(19) United States
(12) Patent Application Publication
(10) Pub. No.: US 2006/0278029 A1
(43) Pub. Date: Dec. 14, 2006

(54) Driving gear selector device for an automatic transmission of a motor vehicle

(75) Inventor: Martin Burgbacher, Esslingen (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 10/526,880

(22) PCT Filed: Aug. 20, 2003
(86) PCT No.: PCT/EP03/09213

§ 371 Date: Nov. 23, 2005

(30) Foreign Application Priority Data
Sep. 10, 2002 (DE) 102 41 877.2

(51) Int. Cl. F16H 61/00

(52) U.S. Cl. 74/335

(57) ABSTRACT

In a gear selection device for an automatic transmission of a motor vehicle, in normal operation, gears selected at a selection lever are set by means of an actuator via a drive element, a driven element and an actuation element. In addition, a parking lock is engaged by means of the driven element. In the event of a failure, at least one position “P” of the gear selection device, and consequently the parking lock, can be engaged by means of an emergency actuation device. In this case, a force or torque limit value of the drive connection between the drive element and the driven element is overshot, so that these can be moved independently of one another. According to the invention, forces or torques up to the force or torque limit value can be transmitted, in accordance with the actuator, between the drive element and the driven element directly after emergency actuation of the driving step selection device.

### BACKGROUND AND SUMMARY OF THE INVENTION

This application claims the priority of German patent document No. 102 41 877.2, filed Oct. 9, 2003 (PCT International Application No. PCT/EP03/09213), the disclosure of which is expressly incorporated by reference herein.

The invention relates to a gear selection device for an automatic transmission of a motor vehicle.

German patent document DE 43 04 250 C1 discloses such a gear selection device for the preselection of various gears (“P”, “R”, “N” and “D”). In normal operation, an actuation element in the form of a selection shaft can be adjusted by an actuator in the form of an electric motor. In gear “P”, a parking lock is engaged, and the motor vehicle is thus secured against rolling away. The actuator is operatively connected to the actuation element via a drive element in the form of a crank and a driven element in the form of a rocker. The drive element is connected to the driven element by means of a coupler. Only forces or torques which are smaller than a force or torque limit value can be transmitted by means of the coupler. When the limit value is overshot, the coupler is pushed together or drawn apart, so that the driven element is uncoupled from the actuator.

The gear selection device has an emergency actuation device in the form of a manually actuatable release lever by which the gear selection device can be actuated in the event of a failure (for example, the failure of the actuator or of an energy source in the form of a vehicle battery). When the emergency actuation device is used, the force or torque limit value is overshot and a position corresponding to the gear “N” is thus set via the driven element, independently of the position of the actuator. In this case, the driven element moves relative to the drive element. After emergency actuation, the driven element is uncoupled from the drive element. For renewed operation of the gear selection device, the coupling must be restored.

By contrast, one object of the present invention is to provide a gear selection device which can be handled in a simple way.

This and other objects and advantages are achieved by the gear selection device according to the invention, in which forces or torques up to the force or torque limit value can be transmitted, in accordance with the actuator, between the drive element and the driven element directly after emergency actuation of the gear selection device; that is, without restoration of a connection or coupling or resetting to the original state. Consequently, the drive connection present in normal operation between the drive element and the driven element is interrupted only during emergency actuation, and is restored immediately after the termination of emergency actuation.

The connection between the drive element and the driven element is comparable in its type of action to an overload clutch, which is known per se and can transmit forces or torques only up to adjustable limit values. In the case of forces or torques above the limit values, a relative movement occurs between a drive side and a driven side of the overload clutch. The operative connection between the drive side and a driven side of the overload clutch may be made nonpositively in the form of a slipping clutch (known per se), or positively.

Thus, after emergency actuation and the subsequent elimination of the failure which led to emergency operation, the gear device can be put into operation again very simply and quickly. This is advantageous, above all, when it is recognized that emergency operation was falsely initiated, improvidently.

The automatic transmission may be designed as an epicyclic transmission, a continuously variable transmission or an automated shift transmission with a single or double clutch. The actuator is activated by a control device and may be electrical, hydraulic or pneumatic. The actuator is drive-connected to the actuation element via the drive element and the driven element. The actuation element may be designed, for example, as a selection slide of the automatic transmission, by means of which selection slide different shift positions can be set in a hydraulic control, or as a parking lock actuation element, for example in the form of a parking lock cone. With an appropriate design of the emergency actuation device, in the event of a failure, any desired gear of the automatic transmission or any desired position of the parking lock can be set. The emergency actuation device may likewise be designed in such a way that, in the event of a failure, only a specific gear or position of the parking lock can be set.

In a refinement of the invention, the gear selection device has two actuation directions, one oriented toward the position “P” (in which the parking lock is engaged), and the other oriented away from “P”. The position “P” is designed as one end position of the selection device. The force or torque limit values for the two actuation directions are different in each case, and the force or torque limit value in one actuation direction is higher than the maximum force or the maximum torque which can be applied by means of the emergency actuation device. Thus, only one movement direction can be executed by means of the emergency actuation device. The connection between the drive element and the driven element is consequently comparable in its type of action to a known ratchet. Such connection may also be designed such that one movement direction is blocked independently of an actuation force or of an actuation torque.

It is consequently possible to define which gears are to be engageable in the event of a failure. This ensures reliable operation of the gear selection device.

In a refinement of the invention, only the gear “P” can be engaged by means of the emergency actuation device. Since the opposite movement direction is blocked, after being engaged once by means of the emergency actuation device, “P” can no longer be left. The motor vehicle is thus secured by means of the parking lock against rolling away, ensuring effective theft protection of the motor vehicle. A coupling of the parking lock to an ignition lock of the motor vehicle ensures particularly reliable operation. In this case, an ignition key can be withdrawn only when the parking lock has been engaged by means of the actuator in normal operation or by means of the emergency actuation device in the event of a failure.

In a refinement of the invention, the gear selection device has an emergency release device, by means of which the gear “P” (and consequently also the parking lock) can be disengaged. The emergency release device can apply a higher force or torque than the emergency actuation device, and can exceed the force or torque limit value necessary for the disengagement of “P”. A movement out of the gear “P” can consequently be initiated by the emergency release device. For example, the gear “N” can be engaged and consequently the parking lock can be disengaged. It therefore becomes possible to tow the vehicle in the event of a failure.

The emergency release device is, in particular, arranged so as to be spaced apart from the emergency actuation device and, for example, can be actuated only with the aid of a special tool. It may also be secured by means of a locking device, ensuring theft protection in addition to the possibility of towing away the motor vehicle.

In a refinement of the invention, the emergency actuation device and/or the emergency release device can be actuated by a vehicle driver who is in a place provided for him. Consequently, in the event of a failure, the vehicle driver can secure the motor vehicle from the driver's seat by means of the parking lock and can also cancel the securing from the driver's seat again, for example for towing away. He therefore does not have to leave the unsecured motor vehicle in the event of a failure, so that the risk that the motor vehicle starts to move uncontrolled, and endangers the vehicle driver or other road users is very low. This ensures reliable operation of the motor vehicle.

The actuation of the emergency actuation device and/or of the emergency release device may be coupled with the actuation of further devices of the motor vehicle, for example with the actuation of a parking brake.

In a refinement of the invention, the emergency actuation device or the emergency release device (or both) may have an energy accumulator which can be triggered by the vehicle driver and/or by means of a trigger actuator. Operation is consequently particularly simple and convenient for the vehicle driver to handle. Moreover, it is possible simply and cost-effectively to ensure that only exactly one gear can be set by means of the emergency actuation device or the emergency release device.

Upon triggering of the energy accumulator by a trigger actuator, advantageously the emergency actuation device can be actuated (and consequently the parking lock engaged) when the vehicle driver withdraws the ignition key or opens a vehicle door. Moreover, the control device which activates the trigger actuator has, in particular, a second energy source (for example a battery) in order to ensure operation even in the event of the failure of a voltage supply of the motor vehicle. Particularly reliable operation of the motor vehicle is thereby ensured.

In a refinement of the invention, the energy accumulator is a pneumatic or hydraulic pressure accumulator. After a triggering of the pressure accumulator, the latter can be filled up again, and consequently made ready for operation again, by a pump (which may also have other functions). This resetting of the pressure accumulator is independent of the other actuation of the gear selection device. Consequently, the actuator and all the other elements of the gear selection device are not subjected to the resetting. The other elements of the gear selection device can thus be designed purely for the setting of the actuation elements. This makes it possible to have a particularly cost-effective design of the gear selection device.

In addition to a pneumatic or hydraulic accumulator, the energy accumulator may also be a spring accumulator.

In a refinement of the invention, the drive element has a mainly circular inner contour and the driven element a mainly circular outer contour, with the drive element at least partially surrounding the driven element. This makes it possible to have a compact construction of the combination of drive element and driven element, and requires only a small amount of construction space.

In a refinement of the invention, the position of the driven element can be detected by the control device by means of a position sensor. For example, the driven element has arranged on it a measuring contour which is operatively connected to the sensor. Consequently, the position of the actuation element (for example, the selection slide or the parking lock actuation element; that is, the achieved action of the gear selection device) can be measured by the control device. Since the drive element and the driven element are of mainly circular design, the position of the drive element with respect to the driven element is unimportant. The activation of the actuator takes place solely on the basis of the position of the transmission member. Consequently, neither resetting of the elements nor adaptation of the actuator to the new position or learning phases of the control device with regard to the new position are necessary in the event of emergency actuation in which the position of the drive element changes with respect to the driven element. Thus, after a failure which led to emergency actuation has been eliminated, the gear selection device can resume normal operation very simply and quickly. Moreover, there is no need for setting work during a mounting of the gear selection device, thus making cost-effective mounting possible.

In a refinement of the invention, the drive element is produced in one piece with an element of the actuator. The otherwise necessary positive or nonpositive coupling of the actuator to the drive element is consequently dispensed with. The gear selection device can therefore be constructed with few components, so that only a small construction space is required and simple, cost-effective mounting becomes possible. The actuator may be designed, for example, as an electric transverse flux machine.

Other objects, advantages and novel features of the present invention will become apparent from the following detailed description of the invention when considered in conjunction with the accompanying drawings.

### BRIEF DESCRIPTION OF THE DRAWINGS

FIG. 1 shows a gear selection device for an automatic transmission of a motor vehicle with an emergency actuation device;

FIG. 2 shows a drive element of the gear selection device;

FIG. 3 shows a blocking bolt of the gear selection device;

FIG. 4 shows a driven element of the gear selection device;

FIG. 5 shows an emergency actuation device with a spring accumulator and an emergency release device; and

FIG. 6 shows an emergency actuation device with a pneumatic pressure accumulator.

### DETAILED DESCRIPTION OF THE DRAWINGS

Referring to FIG. 1, a gear selection device 10 has a selection lever 11, by which a vehicle driver can set the gears “P”, “R”, “N” and “D” of an automatic transmission (not illustrated), of a motor vehicle. The gears can be set sequentially one after the other in the order mentioned. The selection lever 11 is signal-connected to a control device 12 which activates an actuator in the form of an electric motor 13 according to the position of the selection lever 11. The electric motor 13 drives a worm wheel 17 via an output shaft 14, bevel gears 15 and an intermediate shaft 16. The worm wheel 17 engages into a worm toothing (not shown) of a drive element 18, and can thus transmit the movements of the output shaft 14 of the electric motor 13 to the drive element 18.

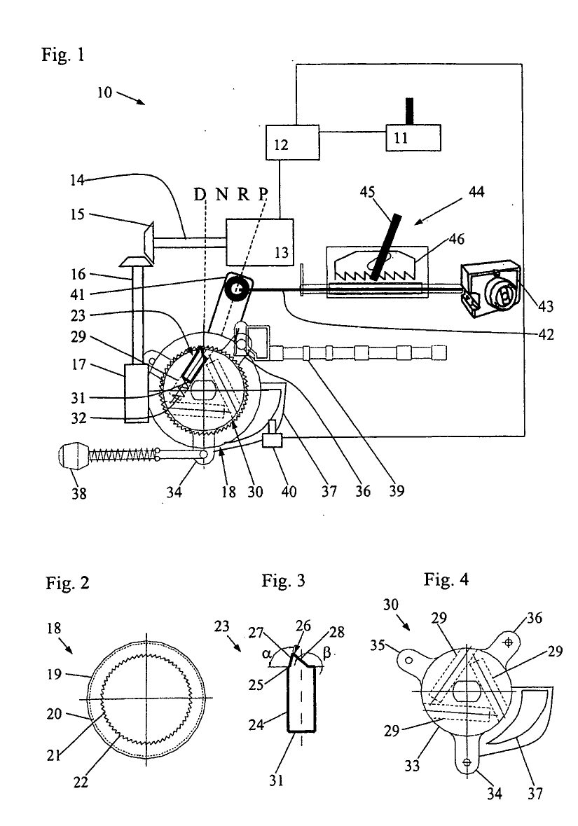

As illustrated in FIG. 2, the drive element 18 has an essentially annular basic shape. On a cylindrical outer contour 19, the drive element 18 has The worm toothing, indicated by a broken reference circle 20. On a circular cylindrical inner contour 21, the drive element 18 has an internal toothing 22, into which a blocking bolt 23 engages, as illustrated in FIG. 1.

As illustrated in FIG. 3, the blocking bolt 23 has a cylindrical basic body 24 and a tooth 26 arranged on one end face 25 of the cylindrical basic body 24. The tooth 26 has two flanks 27 and 28 which have different angles of inclination α and β with respect to the end face 25. The internal toothing 22 of the drive element 18 is designed according to these angles of inclination α, β.

As illustrated in FIG. 1, the blocking bolt 23 is arranged in a cylindrical recess 29 of a driven element 30 which is partially surrounded by the drive element 18. The blocking bolt 23 is acted upon on a bottom face 31 by a spring 32, with a force which presses the blocking bolt 23 with the tooth 25 into the internal toothing 22 of the drive element 18. A drive connection is consequently established between the drive element 18 and the driven element 30. A rotation of the drive element 18 causes the driven element 30 to corotate in normal operation of the gear selection device 10.

With the aid of the flanks α, β of the blocking bolt 23 and of a spring constant of the spring 32, it is possible, for each movement direction, to define a force or torque limit value which cannot be overshot by forces or torques transmitted between the drive element 18 and the driven element 30. When the limit value is overshot, the blocking bolt 23 is pressed into the recess 29 by a force counter to the force of the spring 32, and the drive element 18 and the driven element 30 can rotate independently of one another. The higher the force which presses the blocking bolt 23 into the recess 29, the larger the angle of inclination α, β of the flanks 27, 28 with respect to the end face 25 of the blocking bolt 23. Since the angle of inclination β of the flank 27 is smaller than the angle of inclination β of the flank 28, a higher force can be transmitted in a counterclockwise actuation direction than in a clockwise actuation direction. The angle α of the blocking bolt 23 is selected such that, in a counterclockwise direction, the blocking bolt 23 is never pressed completely into the recess 29. The angle of inclination a may lie, for example, in a range of 100° to 105° (in particular 102.2°), and the angle of inclination β in a range of 136° to 142° (in particular 139°).

As illustrated in FIG. 4, the driven element 30 has a cylindrical basic body 33, with three recesses 29, in each of which a spring 32 and a blocking bolt 23 are arranged. The basic body 33 is surrounded for a large part by the drive element 18. Three fastening lugs 34, 35, 36 are distributed on the circumference, on that part of the basic body 33 which is not surrounded. A measuring contour 37 is additionally attached to the part which is not surrounded.

As illustrated in FIG. 1, the driven element 30 is connected to a parking lock cone 38 via the fastening lug 34. In the illustrated position of the parking lock cone 38, a parking lock (not shown) is engaged, and the motor vehicle is consequently secured against rolling away. The driven element 30 is connected to a selection slide 39 of the automatic transmission via the fastening lug 36. By means of the selection slide 39, different shift positions can be set in a hydraulic control. In the illustrated position of the selection slide, the shift position “P” is set in the automatic transmission.

The measuring contour 37 on the driven element 30 actuates a position sensor 40 which is signal-connected to the control device 12. The control device 12 consequently detects the position of the driven element 30, and therefore also the position of the parking lock cone 38 and of the selection slide 39. The setting of the parking lock cone 38 and of the selection slide 39 are the function of the gear selection device 10, and therefore the result of the setting can be checked by means of the position sensor 40.

In normal operation of the gear selection device 10, the control device 12 activates the electric motor 13, such that the driven element 30 and consequently the parking lock cone 38 and the selection slide 39 assume a position corresponding to the position of the selection lever 11. All the components of the gear selection device 10 which have been mentioned hitherto are arranged within a housing (not shown) of the automatic transmission.

As illustrated in FIG. 1, the driven element 30 is connected fixedly to an emergency actuation lever 41 which corotates in the event of a rotation of the driven element 30. For a clearer understanding, the various positions of the emergency actuation lever 41 in the various gears of the automatic transmission are identified. The emergency actuation lever 41 is connected to an ignition lock 43 by means of a Bowden cable 42. This ensures that an ignition key (not shown) can be withdrawn from the ignition lock 43 only when the emergency actuation lever 41 is in the position illustrated, and consequently the automatic transmission is in the position “P”. The parking lock is therefore also engaged and the motor vehicle is secured against rolling away.

A mechanical emergency actuation device 44 through which the Bowden cable 42 is led is arranged between the emergency actuation lever 41 and the ignition lock 43. In emergency operation of the gear selection device 10 (for example when the electric motor 13 is no longer operating or a vehicle battery, not illustrated, is no longer sufficiently charged), the gear selection device 10 can be actuated by means of the emergency actuation device 44.

For this purpose, the emergency actuation device 44 has a control stick 45 and a pull bar 46. Upon actuation of the control stick 45, the Bowden cable 42 is pulled in the direction of the ignition lock 43 by means of the pull bar 46, and the emergency actuation lever 41 and the driven element 30 are consequently rotated in the direction of the position “P”. If once-only actuation of the control stick 45 is not sufficient, actuation may be repeated as often as is necessary to reach “P”. The force or torque applied by the emergency actuation device 44 is in this case higher than the force or torque limit value which can be transmitted between the drive element 18 and the driven element 30. Consequently, the blocking bolt 23 is pressed into the recess 29 and there is no longer the drive connection between the drive element 18 and the driven element 30. The driven element 30 can consequently be rotated independently of the drive element 18.

Since only a force in the direction of the ignition lock 43 can be transmitted by means of the Bowden cable 42, the gear “P” cannot subsequently be left again.

The emergency actuation device 44 may be arranged in the interior of the motor vehicle, and may be actuatable by the vehicle driver from the driver's seat. The control stick 45 may in this case be connected fixedly to the emergency actuation device 44, or be capable of being plugged in only as required.

Since, even in emergency operation, the ignition key can be withdrawn only in the gear position “P”, in the event of a failure, an indicator (for example an instrument cluster) can indicate to the vehicle driver that the gear “P” (and consequently the parking lock) must be engaged in order to withdraw the key.

As an alternative to the embodiment illustrated, instead of the Bowden cable, a rod (which can transmit forces in the direction of the emergency actuation lever and in the direction of the ignition lock) may also be arranged between the emergency actuation lever and the ignition lock. By means of a correspondingly designed emergency actuation device, all the gears can consequently be engaged in the event of a failure.

The blocking bolts may also be arranged in recesses of the drive element instead of in recesses of the driven element.

FIG. 5 illustrates a second embodiment of an emergency actuation device 144. (For the sake of clarity, only a driven element 130 and an emergency actuation lever 141 of the gear selection device are illustrated.) In the illustrated position of the emergency actuation lever 141, the gear selection device is in the position “D”, the position for forward driving.

The emergency actuation lever 141 has a bore 151 through which a pull rod 152 is led. Part of the pull rod 152 is surrounded by a spring accumulator in the form of a helical spring 153. In normal operation of the gear selection device, the helical spring 153 is tensioned, and is kept under tension, by a trigger pin 154. The trigger pin 154 can be moved by means of a trigger actuator in the form of an electromagnet 155, which is activated by a control device 112. Moreover, the control device 112 is signal-connected to a selection lever 111, to an ignition lock 143 and to a door sensor 156. The door sensor 156 detects when a driver's door (not shown) of the motor vehicle is opened.

In the event that the control device 112 detects a failure of the gear selection device, the electromagnet 155 is activated by a withdrawal of an ignition key (not shown) from the ignition lock 143 or by the opening of the driver's door, in such a way that the trigger pin 154 releases the helical spring 153 and the latter is detensioned. Detensioning of the helical spring 153 causes the emergency actuation lever 141, and consequently the driven element 130, to be moved into the position “P” by the pull rod 152, so that the parking lock is engaged. The force or torque applied by the helical spring 153 is in this case higher than the force or torque limit value which can be transmitted between the drive element and the driven element.

After elimination of the failure which led to emergency operation, the driven element 130, and consequently the emergency actuation lever 141, can be rotated again by the actuator. If, in this case, a position different from “P” is set again, the helical spring 153 is tensioned and the trigger pin 154 can assume the illustrated position again. The emergency actuation device 144 is consequently ready for operation again.

If the motor vehicle is to be moved (for example in order to be towed), in the event of a failure of the gear selection device after the parking lock has been engaged, then the gear “N” can be engaged and consequently the parking lock released by means of an emergency release device 157. The emergency release device 157 is in this case constructed in a manner similar to the emergency actuation device 144. The emergency actuation lever 141 has a second bore 158 through which a second pull rod 159 is led. The latter is partially surrounded by a second spring accumulator in the form of a second helical spring 160. In an illustrated position of readiness of the emergency release device 157, the helical spring 160 is tensioned, and is kept under tension by a second trigger pin 161, which is connected to a release lever 162 that can be actuated by the vehicle driver. Upon actuation of the release lever 162, the trigger pin releases the helical spring 160, which is thereupon detensioned. Consequently, the emergency actuation lever 141 is brought into the position “N” by the pull road 159, and the parking lock is thereby released. The motor vehicle can therefore be moved again.

The force or torque applied by the helical spring 160 is in this case higher than the force or torque limit value which can be transmitted between the drive element and the driven element. The emergency release device 157 is reset correspondingly to the resetting of the emergency actuation device 144.

A signal for triggering the spring accumulator may also be generated by the vehicle driver by a signal generator (not shown) or during the opening of a further door of the motor vehicle. In order to achieve a high availability of the control device 112, the latter may be supplied with voltage by a second energy source (not shown), for example a second battery. In the event of a failure, an indicator can indicate to the vehicle driver that the parking lock is engaged when the ignition key is withdrawn or when the driver's door is opened. The indicator may function, for example, without a voltage supply by the vehicle battery or with a voltage supply by said second energy source.

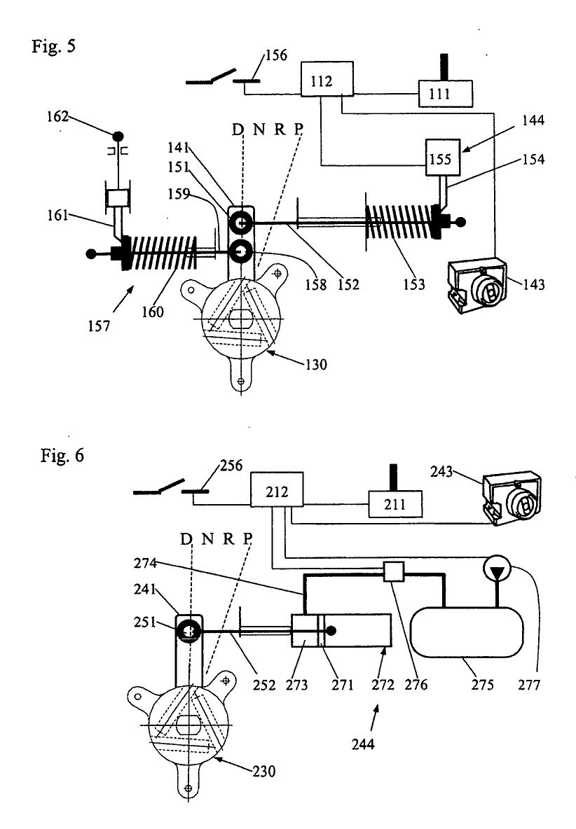

FIG. 6 illustrates a third embodiment of an emergency actuation device 244. For the sake of clarity, only a driven element 230 and an emergency actuation lever 241 of the gear selection device are illustrated. In the illustrated position of the emergency actuation lever 241, the gear selection device is in the position “D”.

The emergency actuation lever 241 has a bore 251 through which a pull rod 252 is led. The latter is connected to a piston 271 of an actuating cylinder unit 272. A pressure chamber 273 of the actuating cylinder unit 272, which faces the emergency actuation lever 241, is connected to a pneumatic pressure accumulator 275 by means of a compressed air line 274. Air under increased pressure is stored in the pressure accumulator 275. The compressed air line 274 can be shut off by means of a valve 276 which is activated by a control device 212. The valve 276 in this case serves as a trigger actuator. Moreover, the control device 212 is signal-connected to a selection lever 211, an ignition lock 243 and a door sensor 256. In normal operation of the gear selection device, the valve 276 is closed, so that the pressure chamber 273 is separated from the pressure accumulator.

If the control device 212 detects a failure of the gear selection device, the valve 276 is opened by a withdrawal of an ignition key (not shown) from the ignition lock 243 or during the opening of the driver's door, and the pressure chamber 273 is thus connected to the pressure accumulator 275. Consequently, the pressure in the pressure chamber 273 rises sharply and a force directed away from the emergency actuation lever 241 acts on the piston 271. As a result, the piston 271 moves away from the emergency actuation lever 241 and, by means of the pull rod 252, rotates the emergency actuation lever 241 (and therefore the driven element 230) into the position “P”. The force or torque applied by the pressure in the pressure chamber 273 is in this case higher than the force or torque limit value which can be transmitted between the drive element and the driven element.

After elimination of the failure which led to emergency operation, the driven element 230, and consequently the emergency actuation lever 241, can be rotated again by means of the actuator. If, in this case, a position different from “P” is set again, the piston 252 is brought into the illustrated position again. The pressure accumulator 275 is filled again by means of a pump 277 which is activated by the control device 212. The emergency actuation device 244 is consequently ready for operation again.

Alternatively, the pressure accumulator may be designed as a hydraulic pressure accumulator, which does not change the type of action of the emergency actuation device.

The gear selection device and the automatic transmission may be activated by one common control device or by two separate control devices.

Parts of the gear selection device, such as, for example, the actuator, may also be arranged outside the housing of the automatic transmission.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-14. (canceled)

15. A gear selection device for an automatic transmission of a motor vehicle, which has an actuator, a drive element, a driven element, at least one actuation element and an emergency actuation device, wherein:
in normal operation, the actuator is drive-connected to the actuation element via the drive element and the driven element, for the predetermination of a gear of the automatic transmission;
forces or torques acting between the drive element and the driven element are limited by predeterminable force or torque limit values;
in emergency operation, the drive connection is released, so that a relative movement between the drive element and the driven element occurs, and the emergency actuation device exerts on the driven element forces or torques which are higher than the force or torque limit values; and
forces or torques can be transmitted, in accordance with the actuator, between the drive element and the driven element directly after emergency actuation of the gear selection device.

16. The gear selection device as claimed in claim 15, wherein:
a gear “P” can be set by means of the gear selection device; and
a parking lock can consequently be engaged by means of the driven element.

17. The gear selection device as claimed in claim 16, wherein:
the gear selection device has two actuation directions;
the force or torque limit values for the two actuation directions are different; and
the force or torque limit value in one actuation direction is higher than the maximum force or the maximum torque which can be applied by means of the emergency actuation device.

18. The gear selection device as claimed in claim 16, wherein only the gear “P” can be engaged by means of the emergency actuation device.

19. The gear selection device as claimed in claim 18, further comprising an emergency release device, by which the gear “P” can be disengaged.

20. The gear selection device as claimed in claim 15, wherein at least one of the emergency actuation device and the emergency release device can be actuated by a vehicle driver who is in a a driver's seat.

21. The gear selection device as claimed in claim 18, wherein at least one of the emergency actuation device and the emergency release device has an energy accumulator that can be triggered by the vehicle driver or by means of a trigger actuator.

22. The gear selection device as claimed in claim 21, wherein the energy accumulator comprises a pneumatic or hydraulic pressure accumulator.

23. The gear selection device as claimed in claim 15, wherein:
the drive element has a substantially circular inner contour;
the driven element has a substantially circular outer contour; and
the drive element at least partially surrounds the driven element.

24. The gear selection device as claimed in claim 15, wherein a position of the driven element can be detected by a control device by means of a position sensor.

25. The gear selection device as claimed in claim 15, further comprising:
at least one blocking bolt which has a basic body and a tooth; and
at least one spring element which acts upon the blocking bolt;
wherein the force or torque can be transmitted from the drive element to the driven element via the blocking bolt.

26. The gear selection device as claimed in claim 25, wherein:
the driven element has at least one recess, in which the blocking bolt and the spring element are arranged; and
the drive element has a toothing on the inner contour; and
the tooth of the blocking bolt engages into the toothing gear.

27. The gear selection device as claimed in claim 26, wherein:
the tooth of the blocking bolt has two flanks;
in each case one flank lies in a force flux during the transmission of the force or of the torque in an actuation direction; and
the flanks have different angles of inclination with respect to the basic body.

28. The gear selection device as claimed in claim 15, wherein the drive element comprises a single piece with an element of the actuator.
